(19) United States
(12) Patent Application Publication
(10) Pub. No.: US 2004/0100756 A1
(43) Pub. Date: May 27, 2004

(54) Aluminum electrolytic capacitor

(75) Inventors: Masayoshi Koizumi, Sannohe-gun (JP); Junkichi Mabe, Sannohe-gun (JP); Yutaka Ozawa, Sannohe-gun (JP); Katsuharu Yamada, Sannohe-gun (JP)

Correspondence Address: KODA & ANDROLIA, Suite 1430, 2029 Century Park East, Los Angeles, CA, 90067-3024, US

(73) Assignee: FUJITSU MEDIA DEVICES LIMITED

(21) Appl. No.: 10/705,130

(22) Filed: Nov. 10, 2003

(30) Foreign Application Priority Data
Nov. 11, 2002 (JP) 2002-327169
Sep. 29, 2003 (JP) 2003-305638

(51) Int. Cl. H01G 9/042

(52) U.S. Cl. 361/509

(57) ABSTRACT

An aluminum electrolytic capacitor has a capacitor element provided with an anode lead terminal and a cathode side lead terminal, a bottomed shield containing the capacitor element and a sealing rubber sealing an opening of the bottomed shield. The number of lead terminals of anode side and cathode side lead terminals, respective lead terminal being drawn out onto the same level of the bottomed shield, is selected from a number range of 2 to 4.

### BACKGROUND OF THE INVENTION

1. Field of the Invention

The present invention relates to an aluminum electrolytic capacitor, such as a type of lengthwise standing or placing enabling to be mounted on the surface of the device.

In particular, the present invention relates to an aluminum electrolytic capacitor having ESR (Equivalent Series Resistance) and ESL (Equivalent Series Inductance), respectively being lowered.

2. Description of the Prior Art

The basic structure of, for example, a wound type solid electrolytic capacitor of the conventional aluminum electrolytic capacitor is identical with the basic structure of a wound type solid electrolytic capacitor which is an example of the aluminum electrolytic capacitor according to the present invention.

A structure of the conventional wound type solid electrolytic capacitor will be explained with reference to FIG. 1, FIG. 2 and FIG. 3A and 3B, respectively shows the prior art, as well as to FIG. 7 showing a partly omitted longitudinal section of the wound type solid electrolytic capacitor, which is showing an embodiment of the aluminum electrolytic capacitor according to the present invention.

As shown in FIG. 7 and FIG. 1 and FIG. 2, the wound type solid electrolytic capacitor has a cylindrical capacitor element 1, a solid electrolytic layer 7, a sealing rubber 8 and a bottomed cylindrical shield 9. The element 1 is formed with an anode aluminum conversion foil 2 having an anode side lead terminal 3 for leading out an anode, the terminal 3 being connected to the foil 2 and an opposite facing type cathode aluminum conversion foil 4, a cathode side lead terminal 5 for leading out a cathode connected to the foil 4. The solid electrolytic layer 7 is formed with a monomer and an oxidation agent impregnated in the capacitor element 1.

As shown FIG. 7, the capacitor element 1 is placed within the bottomed cylindrical shield 9, an opening of the shield 9 is closed by an sealing rubber 8 caulked or drawn transversely and curled sealingly, resulting in a solid electrolytic capacitor.

According to the conventional solid electrolytic capacitor shown in FIG. 1 and FIG. 2, an anode lead terminal 3 and a cathode lead terminal 5, respectively connected to the anode aluminum conversion foil 2 and the opposite facing cathode aluminum conversion foil 4 form a twin type terminal structure having respective lead terminal of anode and cathode.

Also, the basic structure of the conventional longitudinally placed type aluminum electrolytic capacitor enabling to mount on surface of the print substrate, is identical with the basic structure of the longitudinally placed type aluminum electrolytic capacitor according to the other embodiment of the aluminum electrolytic capacitor of the present invention.

Therefore, a structure of the conventional longitudinally placed type aluminum capacitor will be explained with reference to FIG. 12 of a partly omitted longitudinal section showing a longitudinally placed aluminum electrolytic capacitor of the other embodiment of the aluminum electrolytic capacitor according to the present invention, FIG. 15 of a partly omitted perspective view depicting one example of the lead terminal, and FIG. 4 and FIG. 5 depicting the conventional device.

As shown in these figures, the longitudinally placed type aluminum electrolytic capacitor is formed with a cylindrical capacitor element 20, a solid electrolytic layer consisting of monomer and oxidation agent impregnated in the capacitor element 20, a sealing rubber 23, a bottomed cylindrical shield 24, and a heat resisting insulation seat plate 25. The cylindrical capacitor element 20 is made with a dielectric oxidization film, and an anode aluminum foil having an anode side lead terminal 21 for leading out an anode, which terminal being connected to the anode foil, and a cathode aluminum foil facing to the anode foil. The cathode side lead terminal 22 for leading out the cathode is connected to the opposite cathode foil. These anode aluminum foil and cathode aluminum foil are wound and formed with a separating paper placed between these foils.

As shown in FIG. 12, a pair of lead terminals 21, 22, respectively led out from the capacitor element 20 extend through the sealing rubber 23, the capacitor element 20 is contained within the shield 24, an opening of the shield 24 is drawn or squeezed in traverse direction together with the sealing rubber 23, additionally respective flat end portions 21a 22a of the pair of the lead terminals 21, 22 extend through the heat resisting insulation seat plate 25 fitted into the side of sealing rubber 23.

These flat end portions 2la, 22a of the pair of lead terminals 21,22 are bent and placed in dent grooves 25a formed symmetrically in left and right direction in the seat plate 25. Thus, these flat end portions 21a, 22a extend outwardly and placed on a surface of the seat plate 25, these flat end portions 21a, 22a functioning as mounting faces for a print substrate (not shown).

According to the conventional transversely placed aluminum electrolytic capacitor described above, the anode side lead terminal 21 and the cathode side lead terminal 22, respectively connected to the anode aluminum conversion foil and the opposite cathode aluminum conversion foil, have their end portions 21a, 22a as shown in FIG. 4 and FIG. 5. These end portions are of a twin-terminal structure provided with respectively an end portion.

Additionally, according to the conventional aluminum electrolyte capacitors of two kinds mentioned above, these solid type capacitor elements 1 and 20 are formed with an anode conversion foil and a cathode conversion foil which are wound with a separator paper placed between them, and a solid electrolyte layer made of dielectric macromolecule placed between the anode conversion foil and the cathode conversion foil. These solid type capacitor elements 1 and 20 can be replaced by an electrolytic agent type ones, which has an anode conversion foil and a cathode conversion foil. The foils are wound with separator paper placed between them, and electrolytic agent is impregnated in the wound foils.

As described above, according to the conventional aluminum electrolytic capacitors of a wound solid type and a longitudinal placed type, respectively has twin-terminal structure having one anode side lead terminal for leading out the anode and one cathode side lead terminal for leading out the cathode.

By the way, according to the twin terminal structure having respectively the anode side lead terminal for leading out the anode and the cathode side lead terminal for leading out the cathode, as shown in FIG. 6 depicting the conventional structure of the twin terminals, the equivalence circuit has two parts of ESR and ESL which are arranged seriously. Therefore, there is limit in an impedance and ESR (Equivalence Series Resistance) due to a lead terminal resistance and a connection resistance, which is happened between the connection foil and the lead terminal, and furthermore, another limit is happened in the reduction of ESL (Equivalent Series Inductance) due to L (inductance) of the lead terminal.

Also, when the conventional twin-terminal structure is used in the circuit employing a high frequency and flowing relatively high current, heat is generated due to high electric volume of the lead terminal and resistance occurred at the connection portion between the lead terminal and electrode foils, resulting in disadvantageously a problem of not permitting of relatively high current flowing.

### SUMMARY OF THE INVENTION

Nowadays, it is necessary to make the electric circuits small in size and to suitably to handle the high frequency devices, so it is need to make an impedance of capacitors low.

In addition, CPU drive circuits and switching power circuits of computers need at designing them a good absorbability of high frequency noise and ripple current. As a result, it has been necessary of the capacitor enabling to have low ESR (Equivalent Series Resistance) and low ESL (Equivalent Series Inductance).

Considering such requirement and problems of the prior art, the inventor of the present invention has invented the aluminum electrolytic capacitor mentioned above after studying the problems.

Accordingly, one object of the present invention is to provide an aluminum electrolytic capacitor enabling to make ESR (Equivalent Series Resistance) and ESL (Equivalent Series Inductance), respectively low.

Another object of the present invention is to provide an aluminum electrolytic capacitor suitably used in high frequency devices attaining low lead terminal resistance, and absorbing noise, which is effectively low.

In accordance with the aluminum electrolytic capacitor of the present invention, the anode foil and the cathode foil, respectively has a plurality of lead terminals for leading out the electrodes or poles and these 2 to 4 lead terminals are separated by certain distances.

Thus, as shown by two dotted broken lines in FIG. 16, two points of ESR (Equivalent Series Resistance) and ESL (Equivalent Series Inductance) are arranged in parallel. Resistance of the lead terminal of a component of ESR (Equivalent Series Resistance) and connection resistance occurred between the foil and lead terminals are cancelled each other. Correspondingly, comparing the present invention with the conventional twin-terminal type aluminum electrolytic capacitor, it is apparent that the present invention can make ESR and L (Inductance) of the lead terminal respectively low, resulting in low ESL.

The aluminum electrolytic capacitor of the present invention can make a lead terminal resistance low, resulting in a low heat generation from the capacitor itself and obtains a suitable handling of high frequency devices. As a result, it is possible to obtain aluminum electrolytic capacitors having a good noise absorbability and use them as a capacitor enabling to make a larger current comparing to that of the conventional capacitor flow.

### BRIEF DESCRIPTION OF THE DRAWINGS

FIG. 1 is an exploded perspective view depicting a capacitor element used in a conventional electrolytic capacitor of the twin terminal structure.

FIG. 2 is a plan view of the conventional wound type solid electrolytic capacitor of the twin terminal structure.

FIG. 3A is a partly omitted sketchy front view showing a connection condition or manner between the conventional electrode foil and an anode side lead terminal.

FIG. 3B is a partly omitted sketchy front view depicting a connection condition between the conventional electrode foil and a cathode side lead terminal.

FIG. 4 is a front view showing a longitudinally placed aluminum electrolytic capacitor of the conventional twin terminal structure.

FIG. 5 is a bottom view of FIG. 4.

FIG. 6 is an equivalent circuitry view of the conventional twin terminal structure aluminum electrolytic capacitor.

FIG. 7 is a partly omitted longitudinal section of the wound type solid electrolytic capacitor according to an embodiment of the aluminum electrolytic capacitor of the present invention.

FIG. 8 is an exploded perspective view of an embodiment of a capacitor element used in an embodiment of the present invention.

FIG. 9 is a plan view of FIG. 7, showing a four terminal structure wound type solid aluminum electrolytic capacitor according to one embodiment of the present invention.

FIG. 10A is a partly omitted sketchy front view of an embodiment of a connection condition of an electrode foil and an anode side lead terminal in accordance with the present invention.

FIG. 10B is a partly omitted sketchy front view showing a connection manner between an electrode foil and a cathode side lead terminal according to the embodiment of the present invention.

FIG. 11A is a partly omitted sketchy front view depicting a connection manner of an electrode foil with an anode side lead terminal according to another embodiment of the present invention.

FIG. 11B is partly omitted sketchy front view showing a connection condition between an electrode foil and a cathode side lead terminal according to another embodiment of the present invention.

FIG. 12 is a longitudinal section showing another embodiment of lengthwise placing type aluminum electrolytic capacitor of the present invention.

FIG. 13 is a front view of the lengthwise placing type aluminum electrolytic capacitor of the present invention.

FIG. 14 is a bottom view of the longitudinal standing type aluminum electrolytic capacitor of the present invention.

FIG. 15 is a partly omitted perspective view of an embodiment of the lead terminal.

FIG. 16 is an equivalent circuitry obtained from the aluminum electrolytic capacitor of the present invention.

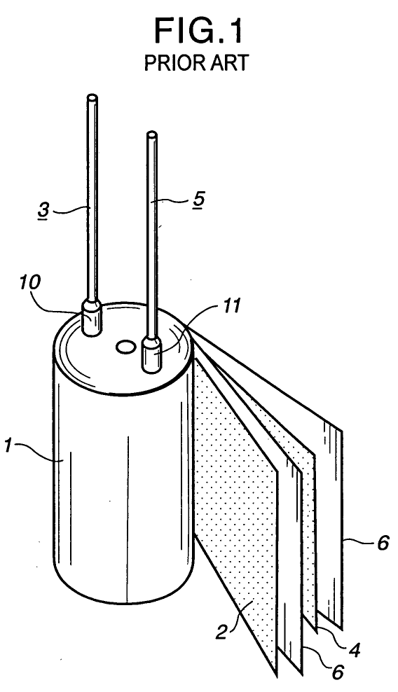

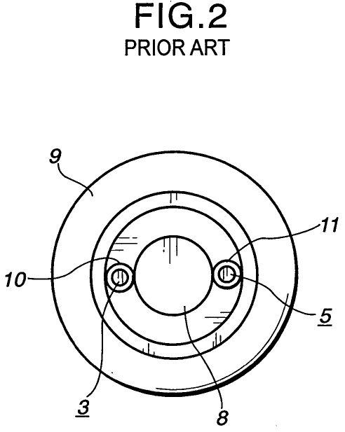

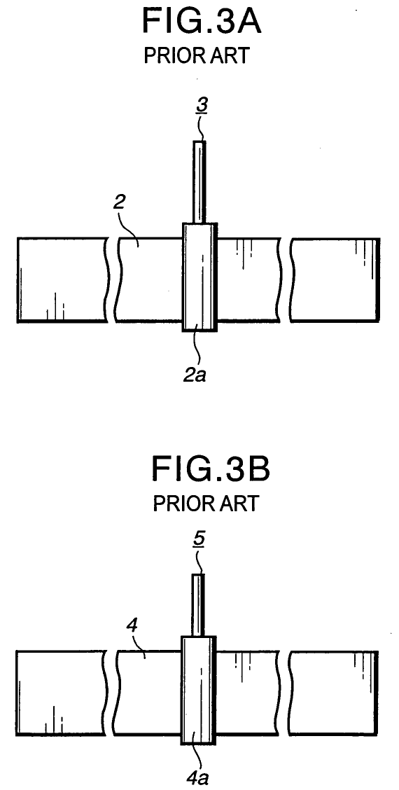

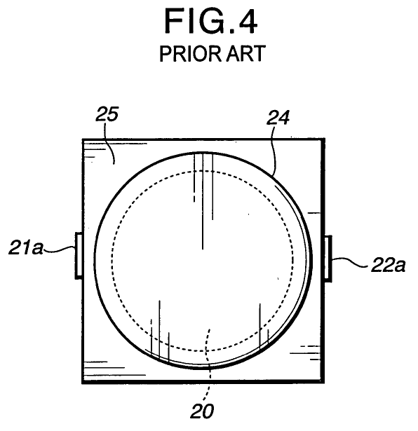

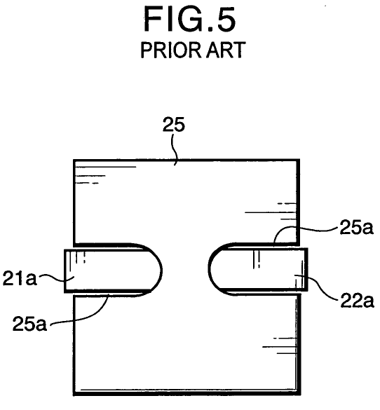

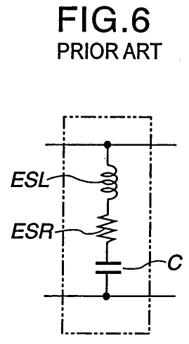

### DESCRIPTION OF THE PREFERRED EMBODIMENTS

The aluminum electrolytic capacitor of the present invention will be explained with reference to the accompanying drawings.

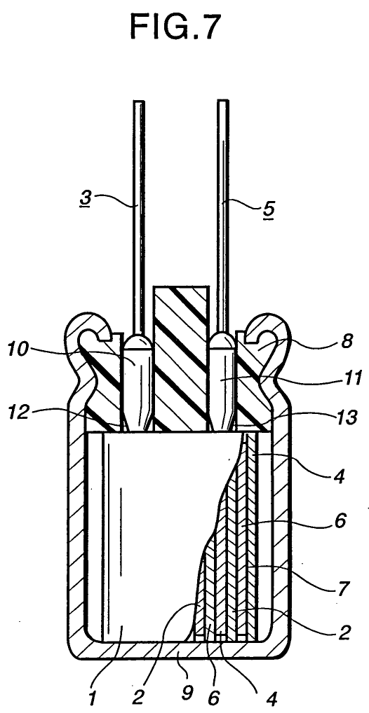

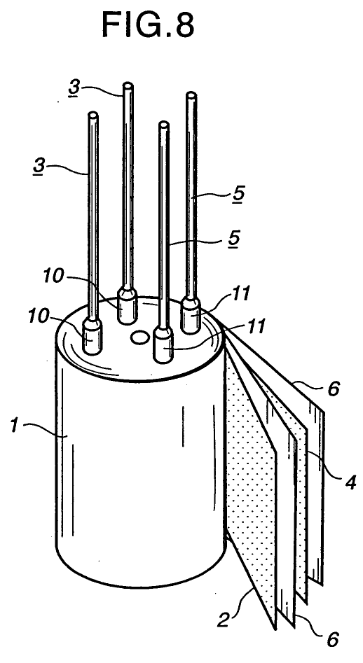

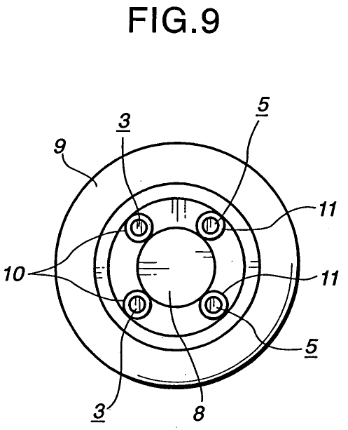

As shown in FIGS. 7, 8 and 9, a wound type solid electrolytic capacitor consists of a capacitor element 1, solid electrolytic layers 7, a sealing rubber 8 and a shield 9.

The capacitor element 1 containing the solid electrolytic layers 7 is encased in the shield 9 together with the sealing rubber 8, and the sealing rubber is transversely curled and squeezed together with the shield 9 in order to completely seal them, resulting in a sealed solid electrolytic capacitor.

The solid electrolytic layer 7 of the solid electrolytic capacitor is made of polypirol (phonetic), polytiophen, polyanilin (phonetic) and the like. In order to reduce ESR (Equivalent Series Resistance), polyethylene, dioxytiophen (phonetic) having low proper resistance is mainly used.

In detail, the aluminum conversion foil is made by adapting an etching treatment and conversion oxidization treatment on an aluminum foil and the aluminum conversion foils are used as an anode and a cathode.

These poles are cut at the predetermined width obtaining an anode conversion foil 2 (thickness: 100 μm). Two anode side lead terminal 3, having certain gap, for leading out an anode side lead are caulked or welded by ultra high frequency sound wave on the anode conversion foil 2.

Also, on the cathode foil 4 (thickness: 80 μm), two cathode side lead terminals 6 for leading out a cathode, which terminals being separately positioned with a certain gap, are caulked or welded by ultra high frequency sound wave.

Then, the cylindrical capacitor element 1 is obtained by wounding the anode conversion foil 2 together with the cathode foil 4 sandwiching a separator paper 6.

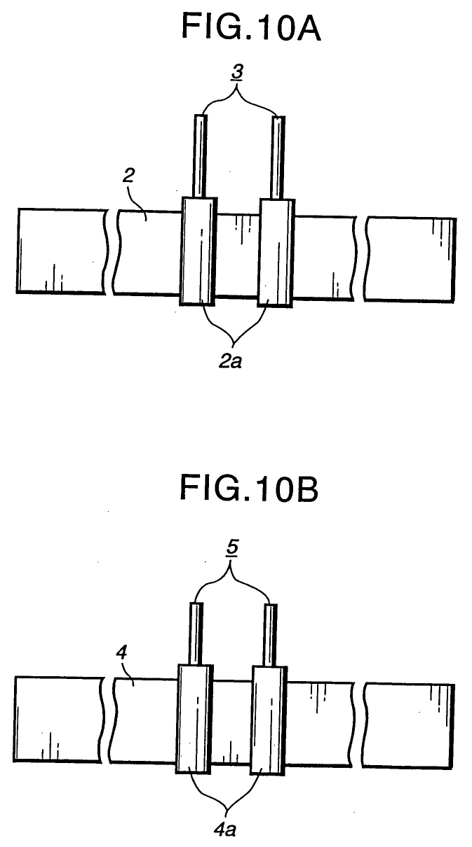

As shown in FIG. 10A and FIG. 10B, two anode side lead terminals 3 and two cathode side lead terminals 5 are connected with these connection portions 2a and 4a of the anode conversion foil 2 and the cathode conversion foil 4 with a certain gap by means of caulking or welding method.

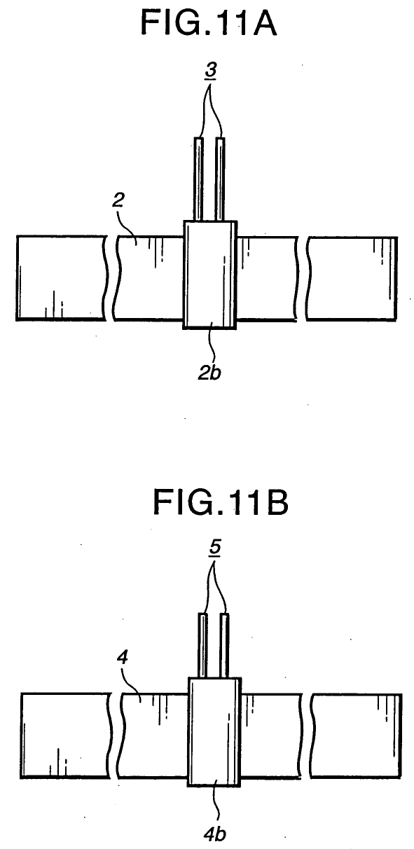

As shown in FIG. 11A and FIG. 11B, the two lead terminals 3 and 5 may be connected with these electrode or pole foils at one position of the common connection portions 2b and 4b at a certain gap.

According to the present invention, the aluminum electrolytic capacitor has the anode side lead terminal 3 and the cathode side lead terminal 5, respectively having two terminals and four terminals in all. When the number of lead terminals is even, such as six and eight terminals, these terminals are connected to the connection portions 2a and 4a with gaps or separately, as that of four terminals structure of the capacitor.

Also, these terminals may be connected to the common connection portions 2b or 4b, separately.

It is noted that when the number of lead terminals is odd, such as five and seven, the lead terminals 3 and 5 are connected to these connection portions 2a, 4a and 2b, 4b, as shown in FIG. 10A, FIG. 10B or 11A, 11B and one terminal is made free. If necessary, and when there is no specific influence, the lead terminals can be connected to the anode and the cathode, not only to the free terminal.

In order to prevent electric conductive high molecule from forming on round bar portions 10 and 11, and on rib portions 12, 13 near the round bar portions of the anode side lead terminal 3 and the cathode side lead terminal 5 of the capacitor element 1, the sealing rubber is applied.

IIR (Isobutylene isopropyrene copolymer rubber) or EPT (Ethylene propylene copolymer rubber), or blend rubber of IIR and EPT may be employed to make the sealing rubber 8. According to the aluminum capacitor of the present invention, IIR (Isobutylene isopropyrene rubber) is used to make the sealing rubber 8.

The conversion film on the capacitor element 1 is formed by the aluminum foil which is previously converted and cut at the predetermined length, so that the valve metal at foil end face may be exposed and the conversion film will be injured by terminal connections, resulting in defects of the converted film.

Accordingly the defects of the converted film are recovered with conversion agent of mainly adipic acid ammonium density: 2%.

In the recovering process, the conversion voltage used to the electrode foil is impressed to the defective portion for 8 to 10 minutes in 35 to 85° C. of conversion agent temperature.

After such conversion process, heat treatment of 200 to 280° C. is applied to the capacitor element 1 for 5 to 10 minutes. The steps of the process are repeated 1 to 5 times in order to reduce the leakage current and improve an impregnation of monomer oxidization agent. Next, 1-butanol solution consisting o 3, 4 ethylene dioxytiophen of conductive high molecule and paratoluen suluphon acid ferric of oxidization agent is impregnated in the capacitor element 1 carrying out a chemical polymerization, so that the solid electrolytic layer 7 consisting of conductive high molecule of polyethylene dioxytiophen is formed.

Such chemical polymerization process is carried out in a continuous heating atmosphere of 40° C. for five hours and 105° C. for four hours.

As described above, the capacitor element 1 having a solid electrolytic layer 7 formed thereon is placed within aluminum made shield of bottomed cylindrical shape and sealed, then surge voltage heat treatment of 125 to 145° C. is carried out onto the element 1 for 60 to 120 minutes. As a result, the wound type solid electrolytic capacitor of a four terminal structure having lead terminals 3, 5 of respectively two formed on the same face or level of the shield 9 is formed.

The electrolytic capacitor manufactured as described above is of a solid type which having a capacitor element provided with the solid electrolytic layer 7. The effect of the electrolytic capacitor of solid type will be obtained by that of electrolytic agent type (not shown here).

The capacitor element of electrolytic agent type is similar to that of solid type. That is , the capacitor element of a solid type is formed by winding and using proton solution or solvent such as ethylene glycol or non-proton solvent such as y butyrolakuton (phonetic), and impregnating an electrolytic agent using ammonium salt and amidine salt of an electrolytic kind.

The capacitor element impregnated with electrolytic agent has lead terminals, a sealing rubber is inserted onto the lead terminals, the elements and the rubber are placed in the bottomed cylindrical aluminum shield and sealed, and last the sealing rubber is caulked.

Next, a longitudinal placed type aluminum electrolytic capacitor enabling to surface-mount on a print substrate in accordance with another embodiment of the aluminum electrolytic capacitor of the present invention will be explained with reference to the accompanying drawings.

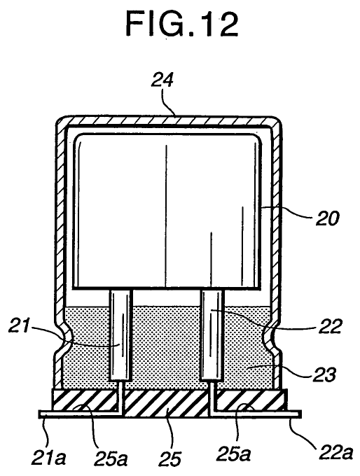

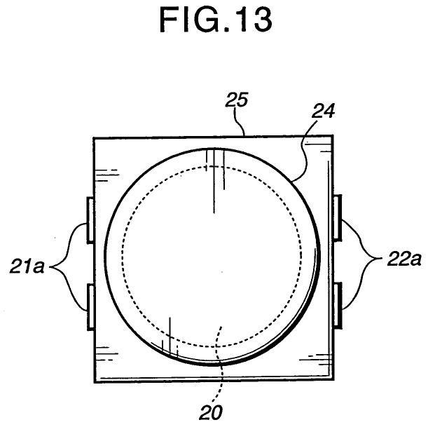

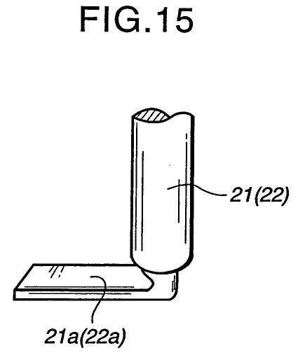

As shown in FIG. 12 to FIG. 15, the longitudinal placed type aluminum electrolytic capacitor of the present invention consists of a cylindrical capacitor element 20, a solid electrolytic layer, a sealing rubber 23, a bottomed cylindrical shield 24, and a heat resisting insulation seat plate 25, wherein the capacitor element 20 has a dielectric oxidization film, an anode. aluminum conversion foil provided with two anode side lead terminals 21 for leading out the anode, which anode side lead terminals being separated and connected therewith by means of caulking or super sonic two welding, and an opposite cathode aluminum conversion foil provided with two cathode side terminals 22 for leading out the cathode, which cathode side lead terminals being separated and connected therewith by means of caulking or super sonic wave welding. These anode aluminum conversion foil and cathode aluminum foil are wound together with a separator paper place between these foils.

Additionally, as to how to connect these lead terminals 21,22 to the electrode foil (25 in FIG. 11), these lead terminal 21 and 22 may be connected to the lead foil through on common connection portion as shown in FIG. 11A and FIG. 11B depicting the connection manner of the wound type solid electrolytic capacitor.

The capacitor element 20 and two lead terminals 21, 22 are contained within the shield 24 at such manner that these lead terminals 21, 22 are led out from the element 20 and extend through the sealing rubber 23, the opening of the shield 24 is squeezed to seal the opening together with the sealing rubber 23, these flat end portions 21a, 22a of the lead terminals 21, 22 pass through the heat resisting insulation seat plate 25 fitted into the shield 24 at a side of the sealing rubber 23, furthermore these flat end portions 21a, 22a of the lead terminals 21, 22 are bent in a symmetrically in left and right directions on the outer face of the seat plate 25 and placed in two grooves 25a or extend outwardly. The end portions 21a, 22a respectively placed on the outer face of the seat plate 25 are used as the mounting face on a print circuit (not shown).

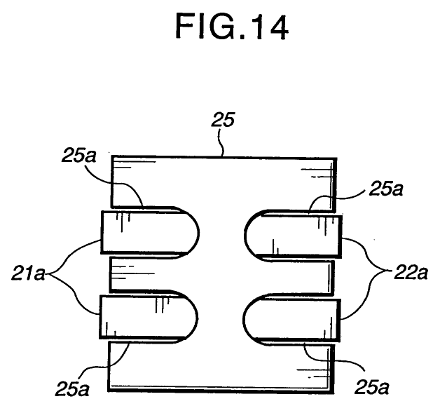

The four terminal structure longitudinal placed aluminum electrolytic capacitor according to the present invention has an anode aluminum foil and an opposite cathode aluminum conversion foil and an anode side and a cathode side lead terminals 21, 22 of respectively two, wherein these lead terminals 21, 22 are connected with these foils respectively, led out from the same level, end portions 21a, 22a of the lead terminals 21, 22 are bent, placed in the groove 25a, and extend symmetrically along a left and right direction as shown in FIG. 12 and FIG. 14.

When an electrolytic agent and longitudinally placed type aluminum capacitor element 20 is used, an effect of the wound type solid electrolytic capacitor can be obtained. The electrolytic agent type aluminum capacitor is not shown.

According to the principle of the present invention, two anode side lead terminals and two cathode side lead terminals make a four terminals structure of the wound type solid aluminum electrolytic capacitor and the longitudinal placed type aluminum electrolytic capacitor.

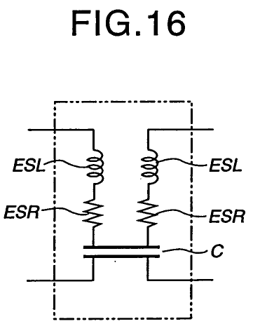

Furthermore, in accordance with the present invention, the capacitor element of the aluminum electrolytic capacitor is of a solid type and of an electrolytic agent type, and the aluminum electrolytic capacitor has a four terminal structure containing two anode side lead terminals and two cathode side lead terminals. Because that the equivalent circuit of these capacitors has, as shown by two-dotted chain lines in FIG. 16, ESR (Equivalent Series Resistance)•ESL (Equivalent Series Inductance) arranged in parallel, it is possible to reduce ESR.

According to the aluminum electrolytic capacitor, it is possible to make an effect of L (Inductance) of the lead terminal zero, so that ESL (Equivalent Series Inductance) will reduce.

The wound type solid electrolytic capacitor according to the embodiment of the present invention and the conventional wound type solid electrolytic capacitor of a comparable example of a two terminal structure manufactured as described above are experienced and the mean value of initial characteristics of electrolytic capacity of the capacitor at a frequency: 120 Hz, ESR (Equivalent Series Resistance) at a frequency: 100 KHz, ESL (Equivalent Series Inductance) at a frequency: 10 MHz will be shown in Table 1 below.

TABLE 1

| | Electrolytic | | |
|---|---|---|---|
| | capacity: 120 Hz | ESR: 100 KHz | ESL: 10 MHz |
| | (μF) | (mΩ) | (nH) |
| Embodiment | 800 | 2.0 | 0.9 |
| Comparison | 795 | 6.0 | 2.4 |

As shown in Table 1 above, the wound type solid electrolytic capacitor according to the embodiment of the present invention has ESR (Equivalent Series Resistance)•ESL (Equivalent Series Inductance), which are considerably reduced comparing to the conventional type solid electrolytic capacitor.

What is claimed is:

1. An aluminum electrolytic capacitor comprising a capacitor element provided with an anode side and a cathode side lead terminals, a bottomed shield containing said capacitor element, and a sealing rubber sealing an opening of the bottomed shield, wherein a number of the anode side and the cathode side lead terminals are respectively selected from the number of 2 to 4.

2. The aluminum electrolytic capacitor according to claim 1, wherein the aluminum electrolytic capacitor can be mounted on the surface of devices and said aluminum electrolytic capacitor is of a longitudinal-placed type.

3. The aluminum electrolytic capacitor according to claim 1 or 2, wherein said anode side and said cathode side lead terminals are formed on the same face of the bottomed shield.

4. The aluminum electrolytic capacitor according to claim 1 or 2, wherein said capacitor element is formed by winding an anode conversion foil, a cathode conversion foil, and a separation paper placed between them and forming a solid electrolytic layer of conductive high molecule between the anode conversion foil and the cathode conversion foil.

5. The aluminum electrolytic capacitor according to claim 1 or 2, wherein said capacitor element is formed by winding the anode conversion foil, the cathode conversion foil, and a separator paper placed between them, and impregnating the wound with electrolytic agent.

6. The aluminum electrolytic capacitor according to claim 4, wherein the conductive high molecule forming said solid electrolytic layer is selected from a group of polypirole, polytiophen, polyanilin, TCNQ acetic acid.

7. The aluminum electrolytic capacitor according to claim 5, wherein the electrolytic agent uses proton solvent of ethylene glycol and the like, non-proton solvent of γ butyrolakton and the like, and electrolytic material uses ammonia salt and amizin salt.

8. The aluminum electrolytic capacitor according to claim 2, wherein said anode side and said cathode side lead terminals are drawn out through the through holes of a heat resistance insulator seat plate, and end portions of said anode side and the cathode side lead terminals are bent so as to contact with an outer face of the heat resistant insulator seat plate and to be used as a mounting face contacting with a print substrate.
